(19) United States
(12) Patent Application Publication
(10) Pub. No.: US 2024/0181826 A1
(43) Pub. Date: Jun. 6, 2024

(54) RESERVOIR FOR AIR SUSPENSION SYSTEM

(71) Applicant: GM GLOBAL TECHNOLOGY OPERATIONS LLC, Detroit, MI (US)

(72) Inventors: Robert Patrick MARBLE, White Lake, MI (US); Gheorghe NICA, North York (CA); Eric B. HOYER, White Lake, MI (US)

(21) Appl. No.: 18/075,072

(22) Filed: Dec. 5, 2022

(51) Int. Cl. B60G 11/27

(52) U.S. Cl. CPC B60G 11/27; B60G 2202/152; B60G 2204/201

(57) ABSTRACT

An air suspension system for a vehicle including an air compressor, a bladder, and an air line. The bladder defines a reservoir configured to store air compressed by the air compressor. The bladder is configured to be seated within a structural member of a frame of the vehicle. The bladder includes a flexible layer covered by an abrasion resistant layer configured to protect the flexible layer from contact with the structural member of the vehicle. An air line fitting is connected to the bladder and in fluid communication with the reservoir. The air line fitting is configured to cooperate with an air line configured to carry air to and from the reservoir.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to an air reservoir for an air suspension system, such as a vehicle air suspension system.

A vehicle air suspension system includes an air compressor and a reservoir. The reservoir stores air compressed by the air compressor until the air is transferred to air spring damper modules of the suspension system. The reservoir is an aluminum or steel tank, which adds mass, cost, and can be challenging to package.

### SUMMARY

In a feature, an air suspension system for a vehicle includes an air compressor, a bladder, and an air line fitting. The bladder defines a reservoir configured to store air compressed by the air compressor. The bladder is configured to be seated within a structural member of a frame of the vehicle. The bladder includes a flexible layer covered by an abrasion resistant layer configured to protect the flexible layer from contact with the structural member of the vehicle. An air line fitting is connected to the bladder and in fluid communication with the reservoir. The air line fitting is configured to cooperate with an air line configured to carry air to and from the reservoir.

In further features, the structural member is a crossmember of the frame.

In further features, the structural member is a rail of the frame.

In further features, the structural member is a trailer hitch crossmember of the frame.

In further features, the structural member is between two rails of the frame.

In further features, the structural member is a housing defined by the frame.

In further features, the flexible layer includes at least one of an elastomeric material and a polymeric material.

In further features, the abrasion resistant layer includes a fabric.

In further features, the fabric includes at least one of nylon and Kevlar®.

In further features, the abrasion resistant layer is secured to the flexible layer with an adhesive.

In further features, the abrasion resistant layer is overmolded onto the flexible layer.

In a feature, an air suspension system includes an air compressor, a flexible bladder, and an air line fitting. The flexible bladder is seated within a rigid structural member of a vehicle frame. The flexible bladder defines a reservoir configured to store air from the air compressor. The flexible bladder includes a flexible layer covered by an abrasion resistant sleeve configured to protect the flexible layer from contact with the rigid structural member. The air line fitting is connected to the flexible bladder and in fluid communication with the reservoir. The air line fitting is configured to cooperate with an air line configured to convey air to the reservoir. Upon being filled with compressed air from the air compressor, the flexible bladder is configured to expand against an inner surface of the rigid structural member to retain the flexible bladder within the rigid structural member.

In further features, the rigid structural member is a crossmember of the vehicle frame.

In further features, the rigid structural member is a rail of the vehicle frame.

In further features, the rigid structural member is between two rails of the vehicle frame.

In further features, the flexible layer includes at least one of an elastomeric material and polymeric material; and the abrasion resistant sleeve includes a fabric configured to protect the flexible bladder from abrasion.

In a feature, an air suspension system includes a rigid crossmember of a vehicle frame, an air compressor mounted to the vehicle frame, a flexible bladder, a fabric sleeve, and an air line fitting. The flexible bladder is within the rigid crossmember and in contact with an inner surface of the rigid crossmember to retain the flexible bladder within the rigid crossmember. The flexible bladder includes a flexible layer defining a reservoir configured to store air from the air compressor. The fabric sleeve covers an outer surface of the flexible layer. The air line fitting is connected to the flexible bladder and in fluid communication with the reservoir, the air line fitting configured to cooperate with an air line configured to convey air to and from the reservoir. The flexible bladder is expandable from a relaxed, unfilled configuration to an inflated, filled configuration when the reservoir is filled with compressed air from the air compressor. In the inflated, filled configuration more of the flexible bladder contacts the inner surface of the rigid crossmember than in the relaxed, unfilled configuration. The air line is configured to direct air from the reservoir to an air spring and damper module of the air suspension system.

In a feature, the flexible layer includes at least one of an elastomeric material and a polymeric material. The fabric sleeve includes at least one of nylon and Kevlar®.

In a feature, the fabric sleeve is connected to the flexible layer with an adhesive.

In a feature, the fabric sleeve is overmolded onto the flexible layer.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a perspective view of a vehicle frame including an air suspension system, the air suspension system has flexible bladders defining air reservoirs in accordance with the present disclosure;

FIG. 2 is a detailed view of a rear area of the vehicle frame of FIG. 1;

FIG. 3 is a plan view of the rear area of the vehicle frame of FIG. 1;

FIG. 4A is a cross-sectional view taken along line 4A-4A of FIG. 3 showing one of the bladders in a relaxed, unfilled configuration;

FIG. 4B is a cross-sectional view showing the bladder of FIG. 4A in an inflated configuration full of compressed air;

FIG. 5 is a side view of the rear area of the vehicle frame of FIG. 1; and

FIG. 6 is a detailed perspective view of an air line connection to one of the bladders of the present disclosure.

In the drawings, reference numbers may be reused to identify similar and/or identical elements.

### DETAILED DESCRIPTION

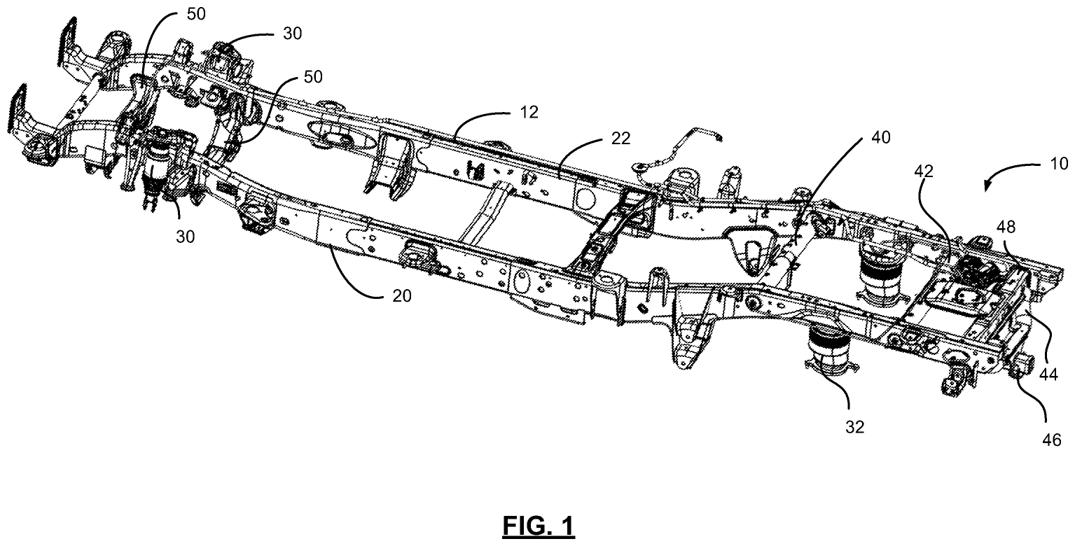

FIG. 1 illustrates an air suspension system 10 in accordance with the present disclosure. The air suspension system 10 is installed on a frame 12 of a vehicle. The air suspension system 10 may be included with any suitable frame of any suitable vehicle. Thus, the present disclosure is not limited to the exemplary frame 12 as illustrated. The air suspension system 10 of the present disclosure may be adapted for use in any suitable non-vehicular application as well.

The exemplary frame 12 includes a first rail 20 and a second rail 22. The first rail 20 and the second rail 22 are rigid members arranged opposite to each other and extend generally along a length of the vehicle. Various components of the air suspension system 10 are supported by the first rail 20 and the second rail 22. For example, front air spring damper modules 30 and rear air spring damper modules 32 are supported by the first rail 20 and the second rail 22. The front and rear air spring damper modules 30, 32 include flexible bellows. Air is added to, or released from, the flexible bellows to modify vehicle performance and/or enhance ride comfort.

Extending between the first rail 20 and the second rail 22 are a plurality of crossmembers, each of which is rigid and increases the rigidity of the frame 12. For example and as illustrated in FIGS. 1-3, a first crossmember 40 and a second crossmember 42 extend between the first rail 20 and the second rail 22 near a rear of the frame 12. At the rear of the frame 12, a hitch crossmember 44 extends between the first rail 20 and the second rail 22. The hitch crossmember 44 supports a trailer hitch 46. Above the hitch crossmember 44 is a rearend crossmember 48. Frontend crossmembers 50 are proximate to a front of the frame 12 on opposite sides of the front air spring damper modules 30.

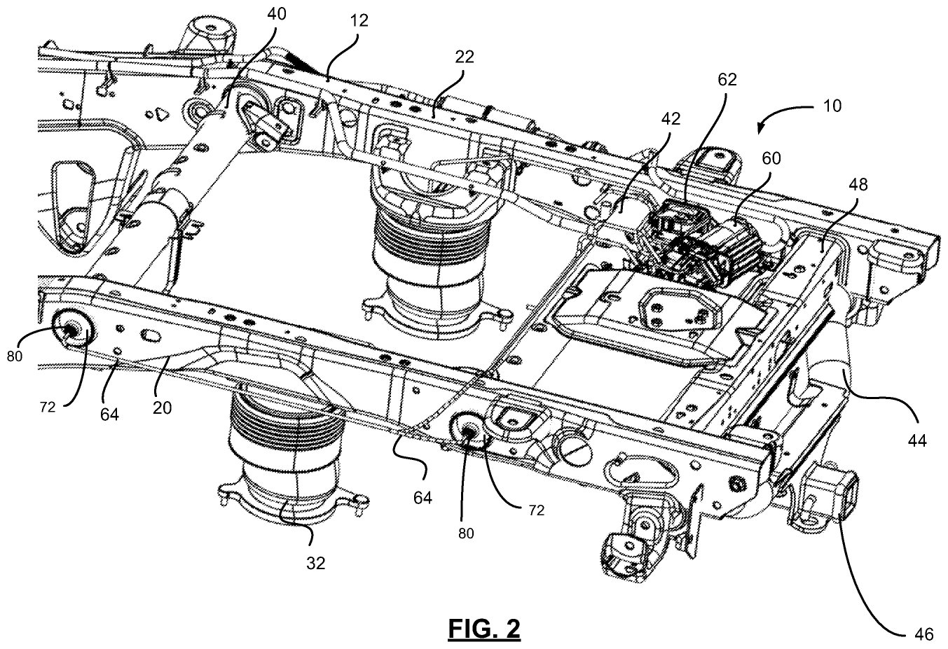

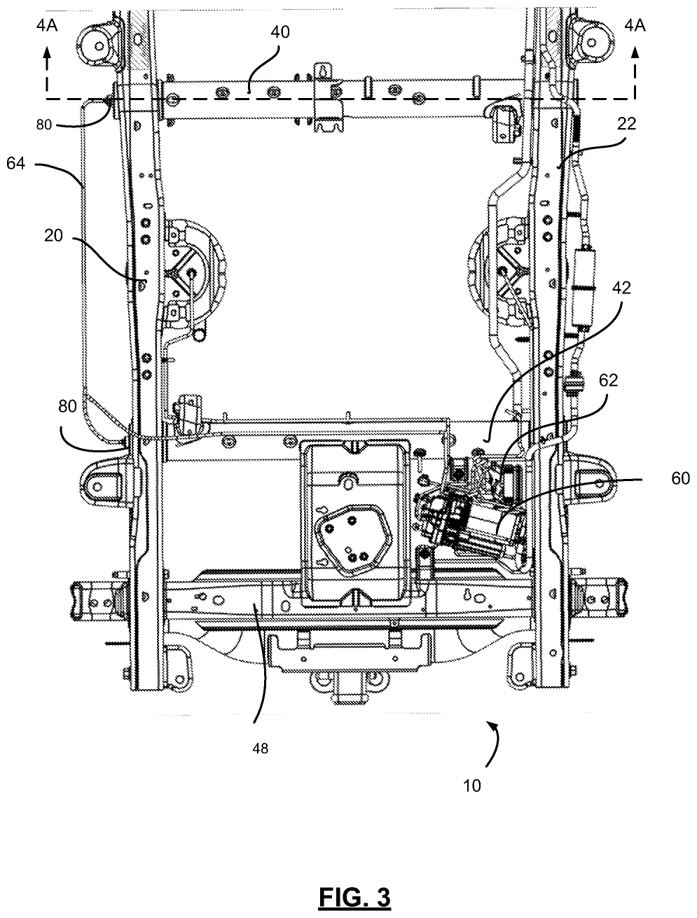

With particular reference to FIGS. 2 and 3, the air suspension system 10 further includes an air compressor 60, an air management module 62, and a plurality of air lines 64. In the example illustrated, the air compressor 60 and the air management module 62 are mounted to the frame 12 between the second crossmember 42 and the rearend crossmember 48. The air management module 62 is configured to operate the air compressor 60 to compress air. The air management module 62 is further configured to direct compressed air through the air lines 64 to one or more of the front air spring damper modules 30 and the rear air spring damper modules 32 depending on various factors. Exemplary factors may include, but are not limited to, selected drive mode, road conditions, vehicle speed, vehicle weight, etc.

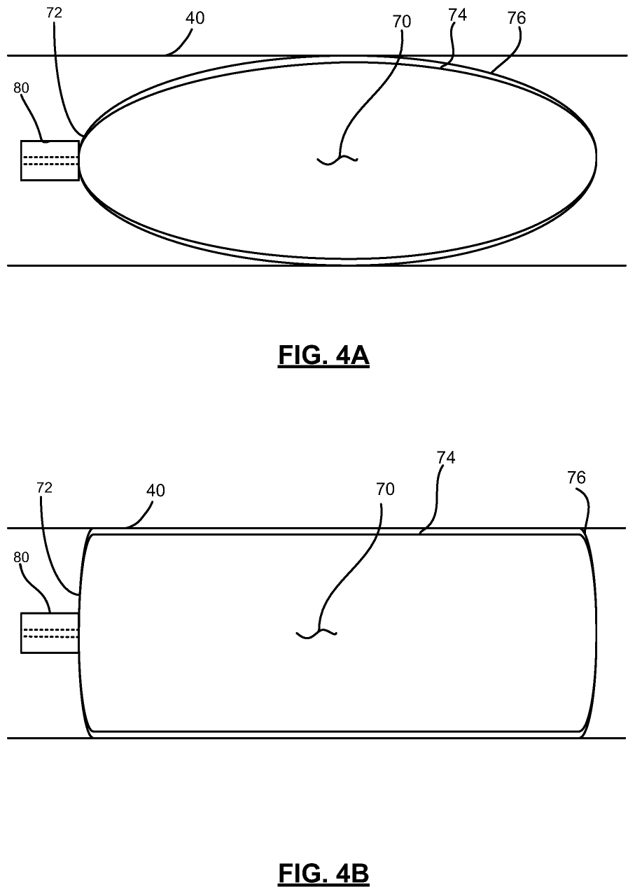

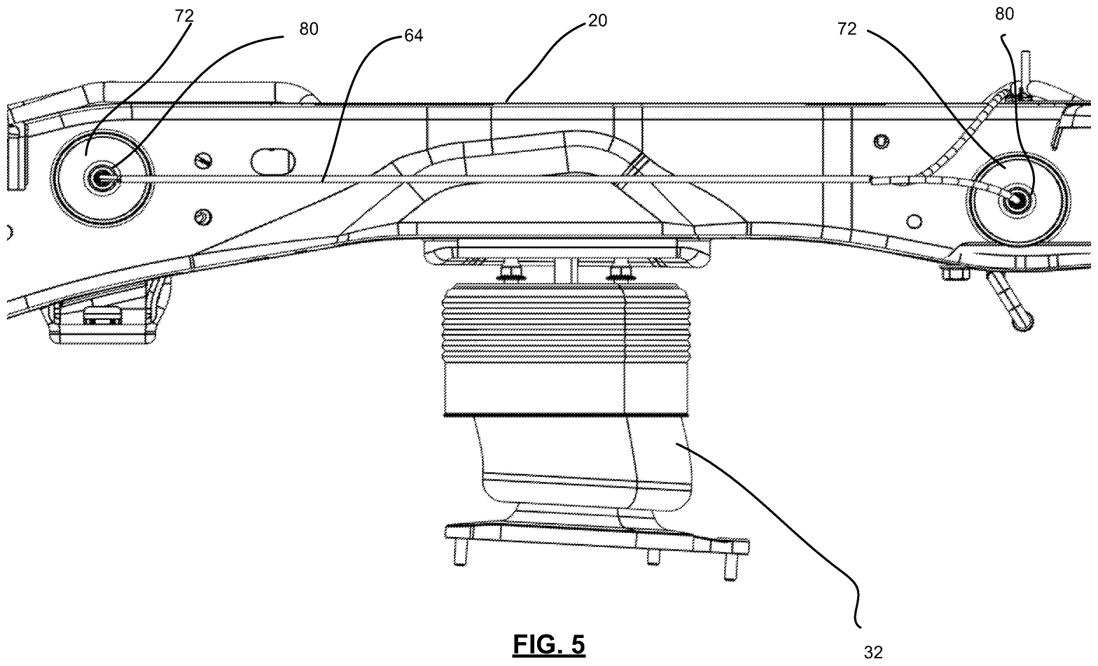

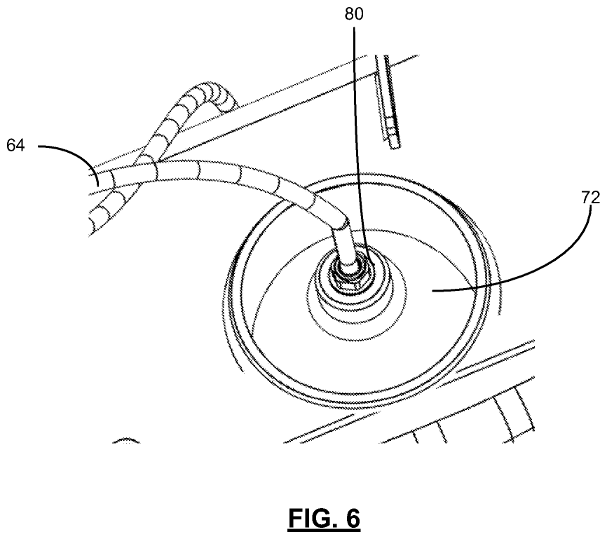

The air suspension system 10 further includes a reservoir 70 defined by a bladder 72, as illustrated in FIGS. 4A and 4B, for example. The bladder 72 is flexible, and configured to expand from a relaxed configuration in FIG. 4A to an expanded or inflated configuration in FIG. 4B when filled with compressed air from the air compressor 60. The bladder 72 is biased to return to the relaxed configuration in FIG. 4A as air exits the reservoir 70. The reservoir 70 is configured to store air compressed by the compressor 60 until the air is needed by one or more of the front air spring damper modules 30 or the rear air spring damper modules 32. The air management module 62 is configured to direct air from the reservoir 70, through the air lines 64, and to one or more of the front and rear air spring damper modules 30, 32, such as by actuating various valves of the air suspension system 10.

The bladder 72 is seated within any suitable housing of the frame 12 or the vehicle generally. The housing may be any suitable rigid structural member of the frame 12. Suitable rigid structural members of the frame 12 include, but are not limited to, the following: the first rail 20; the second rail 22; the first crossmember 40; the second crossmember 42; the rearend crossmember 48; the frontend crossmembers 50; a tower brace; a bumper beam; a body pillar, etc. In the example illustrated, both the first crossmember 40 and the second crossmember 42 house one of the bladders 72. The bladder 72 may be seated within any suitable non-structural member as well. For example, the bladder 72 may be seated in the hitch crossmember 44, a running board, an assist step, etc.

With particular reference to FIGS. 4A and 4B, the bladder 72 includes a flexible layer 74 covered by a protective abrasion resistant layer 76. The flexible layer 74 may be made of any suitable flexible material, such as any suitable elastomeric or polymeric flexible material, that is biased to retract from the expanded, inflated configuration of FIG. 4B to the relaxed configuration of FIG. 4A after the reservoir 70 has been emptied of compressed air. The flexible layer 74 is configured to maintain the bladder 72 in the relaxed configuration of FIG. 4A until the reservoir 70 is again filled with compressed air. In the relaxed configuration of FIG. 4A, the bladder 72 maintains contact with the interior of the first crossmember 40 to retain the bladder 72 within the first crossmember 40. Thus, in the relaxed configuration of FIG. 4A, the bladder 72 has a diameter that is the same as, or slightly larger than, an inner diameter of the first crossmember 40 (or any other suitable housing that the bladder 72 is seated in).

The abrasion resistant layer 76 is made of any suitable material configured to protect the flexible layer 74 from contact with the housing that the bladder 72 is seated in. For example, the abrasion resistant layer 76 may be made of any suitable protective fabric configured to protect the flexible layer 74 from being damaged by contact with the interior of the first crossmember 40. The abrasion resistant layer 76 is configured to protect the flexible layer 74 from any possible wear and/or puncture that may result from contact with a roughened inner surface of the housing, such as a roughened inner surface of the first or second crossmembers 40, 42, for example. The abrasion resistant layer 76 may be made of any suitable abrasion resistant fabric including, but are not limited to, nylon and Kevlar® from DuPont de Nemours, Inc. The abrasion resistant layer 76 may be secured to the flexible layer 74 in any suitable manner, such as with any suitable adhesive. The abrasion resistant layer 76 may also be over molded onto the flexible layer 74.

An air line fitting 80 is connected to the bladder 72 and in fluid communication with the reservoir 70. The air line fitting is connected to the bladder 72 in any suitable manner. For example, the bladder 72 may be over molded on the fitting 80. The fitting 80 is configured to cooperate with the air line 64 to place the reservoir 70 in fluid communication with the compressor 60 to allow compressed air to flow from the compressor 60 into the reservoir 70 by way of the air line 64.

The bladder 72 may be installed in any suitable manner. For example, to install the bladder 72 within the first crossmember 40, the air line 64 is attached to the fitting 80 and the air line 64 is fed through the first crossmember 40. Then, the air line 64 is pulled further to draw the bladder 72 into the first crossmember 40 until an entirety of the bladder 72 is seated in the first crossmember 40. The bladder 72 is sized and shaped such that even when the bladder 72 is in the relaxed, unfilled, configuration of FIG. 4A, the bladder 72 contacts the interior of the first crossmember 40. Friction between the bladder 72 and the interior of the first crossmember 40 retains the bladder 72 within the first crossmember 40. The bladder 72 may be sized and shaped to provide a friction fit with any other suitable housing, such as any other suitable structural member of the frame 12.

When the reservoir 70 is filled with air, the bladder 72 expands within the first crossmember 40, as illustrated in FIG. 4B. As the bladder 72 expands, additional surface area of the flexible bladder 72 (specifically the abrasion resistant layer 76) contacts the interior of the first crossmember 40. Friction between the abrasion resistant layer 76 and the interior walls of the first crossmember 40 further retains the flexible bladder 72 within the first crossmember 40. The bladder 72 may similarly be installed in any other suitable housing, such as the first rail 20, the second rail 22, the second crossmember 42, the hitch crossmember 44, the rearend crossmember 48, and either of the frontend crossmembers 50, for example. The present disclosure thus provides for an air suspension system 10 that saves weight, reduces complexity, and reduces costs by eliminating a separate aluminum or steel air reservoir.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

What is claimed is:

1. An air suspension system for a vehicle, the air suspension system comprising:
an air compressor;
a bladder defining a reservoir configured to store air compressed by the air compressor, the bladder configured to be seated within a structural member of a frame of the vehicle, the bladder including a flexible layer covered by an abrasion resistant layer configured to protect the flexible layer from contact with the structural member of the vehicle; and
an air line fitting connected to the bladder and in fluid communication with the reservoir, the air line fitting configured to cooperate with an air line configured to carry air to and from the reservoir.

2. The air suspension system of claim 1, wherein the structural member is a crossmember of the frame.

3. The air suspension system of claim 1, wherein the structural member is a rail of the frame.

4. The air suspension system of claim 1, wherein the structural member is a trailer hitch crossmember of the frame.

5. The air suspension system of claim 1, wherein the structural member is between two rails of the frame.

6. The air suspension system of claim 1, wherein the structural member is a housing defined by the frame.

7. The air suspension system of claim 1, wherein the flexible layer includes at least one of an elastomeric material and a polymeric material.

8. The air suspension system of claim 1, wherein the abrasion resistant layer includes a fabric.

9. The air suspension system of claim 8, wherein the fabric includes at least one of nylon and Kevlar®.

10. The air suspension system of claim 1, wherein the abrasion resistant layer is secured to the flexible layer with an adhesive.

11. The air suspension system of claim 1, wherein the abrasion resistant layer is overmolded onto the flexible layer.

12. An air suspension system comprising:
an air compressor;
a flexible bladder seated within a rigid structural member of a vehicle frame, the flexible bladder defining a reservoir configured to store air from the air compressor, the flexible bladder including a flexible layer covered by an abrasion resistant sleeve configured to protect the flexible layer from contact with the rigid structural member; and
an air line fitting connected to the flexible bladder and in fluid communication with the reservoir, the air line fitting configured to cooperate with an air line configured to convey air to the reservoir;
wherein upon being filled with compressed air from the air compressor, the flexible bladder is configured to expand against an inner surface of the rigid structural member to retain the flexible bladder within the rigid structural member.

13. The air suspension system of claim 12, wherein the rigid structural member is a crossmember of the vehicle frame.

14. The air suspension system of claim 12, wherein the rigid structural member is a rail of the vehicle frame.

15. The air suspension system of claim 12, wherein the rigid structural member is between two rails of the vehicle frame.

16. The air suspension system of claim 12, wherein:
the flexible layer includes at least one of an elastomeric material and polymeric material; and
the abrasion resistant sleeve includes a fabric configured to protect the flexible bladder from abrasion.

17. An air suspension system comprising:
a rigid crossmember of a vehicle frame;
an air compressor mounted to the vehicle frame;
a flexible bladder within the rigid crossmember and in contact with an inner surface of the rigid crossmember to retain the flexible bladder within the rigid crossmember, the flexible bladder including a flexible layer defining a reservoir configured to store air from the air compressor;
a fabric sleeve covering an outer surface of the flexible layer; and
an air line fitting connected to the flexible bladder and in fluid communication with the reservoir, the air line fitting configured to cooperate with an air line configured to convey air to and from the reservoir;
wherein:
the flexible bladder is expandable from a relaxed, unfilled configuration to an inflated, filled configuration when the reservoir is filled with compressed air from the air compressor;
in the inflated, filled configuration more of the flexible bladder contacts the inner surface of the rigid crossmember than in the relaxed, unfilled configuration; and
the air line is configured to direct air from the reservoir to an air spring and damper module of the air suspension system.

18. The air suspension system of claim 17, wherein
the flexible layer includes at least one of an elastomeric material and a polymeric material; and
the fabric sleeve includes at least one of nylon and Kevlar®.

19. The air suspension system of claim 17, wherein the fabric sleeve is connected to the flexible layer with an adhesive.

20. The air suspension system of claim 17, wherein the fabric sleeve is overmolded onto the flexible layer.
